(19) United States
(12) Patent Application Publication
(10) Pub. No.: US 2021/0092909 A1
(43) Pub. Date: Apr. 1, 2021

(54) PLANT CARE TUBES AND METHOD FOR USING PLANT CARE TUBES

(71) Applicant: Terence Doyle, Lake George, NY (US)

(72) Inventor: Terence Doyle, Lake George, NY (US)

(21) Appl. No.: 16/587,038

(22) Filed: Sep. 29, 2019

(51) Int. Cl. A01G 13/02

(52) U.S. Cl. CPC A01G 13/0243; A01G 13/0237

(57) ABSTRACT

An apparatus for helping plant growth, including a first tube having a cross-section and a width to accommodate lateral growth, and having a length to surround at least half the height of the foliage and at least half the depth of the roots. The first tube has a top and bottom end, the bottom end having attachment features that engage with the attachment features of a removably attachable bottom to form a nursery pot. The first tube is cylindrical or square with a length of 10 to 14 inches, and a diameter or width of 10 inches, the corresponding removably attachable bottom being similarly sized and shaped. A second tube has a similarly shaped cross-section, with a width 1-3 inches wider and a length 1-3 inches longer than the first tube. A method for growing plants from seedlings and a set of tubes for helping plant growth are also presented.

### FIELD OF THE INVENTION

This invention relates to apparatus and methods for promoting the growth of plants, and more particularly to apparatus and methods for protecting and caring for seedlings and young plants.

### BACKGROUND OF THE INVENTION

Upon the arrival of spring one tries to grow and harden seedlings for transplant to the garden. Wind can cause damage to seedlings, so some protection is needed. Various devices are known to protect seedlings and young plants.

For example, in U.S. Pat. No. 6,588,143 B1 a single cone shaped, multi-use garden accessory is taught for providing protection of garden plants from wind and other weather conditions, as well as protection from garden pests. The garden accessory is open at each end, and is made from a translucent semi-rigid or rigid material.

Another example is U.S. Pat. No. 195,913, wherein a single glass tube is used to protect a plant. However, glass is neither cost-effective or user-friendly, and the single glass tube cannot be used after the plant grows bigger than the single glass tube can accommodate.

Yet another example is U.S. Pat. No. 6,038,810 which teaches a conical plant enclosure for outdoor use that has a hollow body with open upper and lower ends, also having ventilation and drainage openings. The base of the body has plant root openings, positioned to be buried beneath the soil surface, the openings being sized to permit plant roots to grow laterally outward close to the soil surface, beyond the perimeter of the enclosure. A lid is engageable to the upper rim of the body.

Further, US Patent Application 2010/0299993 A1 teaches a biodegradable spectrally-selective grow tube or tree shelter that rests on the ground and protectively surrounds a young plant. The grow tube provides an enhanced micro climate that selectively propagates photosynthetically active electromagnetic radiation (visible light). Various embodiments include separate interior and exterior members, the interior member being dyed or pigmented to selectively transmit wavelengths of the visible light spectrum known to promote photosynthesis, such as red light and/or blue light.

Also, U.S. Pat. No. 652,736A teaches a single conically-shaped plant guard and support, the plant guard having a top opening substantially wider than the bottom opening.

### SUMMARY OF THE INVENTION

The plant care tubes of the invention include a plant care tube with a removably attachable bottom. When attached to a plant care tube, the removably attachable bottom essentially transforms the plant care tube into a nursery pot. The removably attachable bottom can be removed from the plant care tube when it is time to transplant a seedling or young plant outside, thereby making the transplant process easier and less disruptive to the roots of a young plant. The removably attachable bottom can be solid, or can have drainage holes, depending on the grower's setup.

This “nursery pot” is still essentially shaped like a tube, in that the removably attachable bottom is of the same shape as the cross-sectional shape of the plant care tube, e.g., circular or square with rounded corners.

The removably attachable bottom has molded attachment features that are cooperative with molded attachment features at the bottom end of a plant care tube. By engaging the molded attachment features of the bottom with the molded attachment features at the bottom of the plant care tube, the removably attachable bottom can be attached in a secure manner to the plant care tube.

In some embodiments, clips can be used to join the molded attachment features of the removably attachable bottom with the molded attachment features of the plant care tube. In other embodiments, the molded attachment features of the removably attachable bottom are configured to directly engage with the molded attachment features of the plant care tube.

The “nursery pot” formed thereby can be advantageously used in a nursery or greenhouse operation, as well as in smaller scale situations, such as hobby gardens.

For growing plants from seedlings, one can first use a small pot (e.g., 3 ½″×5″) as the first pot before transplanting the seedling into a plant care tube with a removably attachable bottom. Or one can start seedlings directly in a plant care tube with a removably attachable bottom.

Once the seedling outgrows the small pot, the growing plant can be transplanted to the plant care tube with a removably attachable bottom so as to accommodate further growth. This plant care tube can be a convenient size (such as 4″×8″). This size facilitates storing the plant care tubes with bottoms in a 10×20 plant tray. About 16-18 pots will fit the 10×20 tray. As the plants mature and more space is needed, there will be need for more trays.

A plant care tube with a removable bottom will retain the potting soil, and will also provide a vehicle for further transplant. When the plant is ready for transplant to a garden, or to a larger plant care tube, the removable bottom is separated from the plant care tube before the plant care tube, along with the plant, is installed in the garden or larger plant care tube.

Plant care tubes come in multiple sizes, and the size used depends on the stage and type of plant to be grown.

Because a plant care tube has straight walls, such as with a cylinder or square plant care tube, the plant care tube can be pushed into the ground, so as to protect the root system of seedlings and young plants, and so as to direct the water to the root system.

Also, the top portion of a plant care tube effectively provides a volume of space that acts as a water reservoir and a measuring cup, so that a hose can be used to provide a consistent amount of water each time the plant is watered, thereby conserving water and using the water efficiently to help the roots of the plant.

Because of the nature of the plant care tube's inherent water reservoir when the tube is filled with soil, a plant care tube naturally promotes root growth from the surface downward. Therefore as each watering is performed, the water is immediately absorbed by the plant, from top to bottom of the root system. Also, when plant nutrition supplements are added to the water, such as fertilizer, epsom salts, and/or calcium nitrate, for example, there is an immediate effect.

Because water poured into the water reservoir (formed by about six inches of the wall of the tube that extends above the soil within the tube) takes a period of time to be absorbed into the lower 6″ of the tube, root growth is promoted from the immediate surface downward, thereby facilitating a more efficient absorption of water and nutrients.

Thus, a key benefit of using a plant care tube is the gravity fed watering system provided by the reservoir formed by the 6″ of tube not filled with soil at the top end of the plant care tube. The volume of the 6″ of tube not filled with soil at the top end of the plant care tube can be filled with water, which then directly targets the plant root base below, thereby making a healthy and full-bearing vegetable yield. Filling of the reservoir with water also helps to minimize water waste, since all that is needed is to fill the reservoir portion of the tube to the top every other day or as needed.

The plant care tube is meant to promote the growth of seedlings, transplants, and existing plants. Also, seeds can be directly planted in the plant care tube.

A plant care tube can be made from a durable plastic, and can be 8-12″ in length and 10-24″ in diameter, for example.

A plant care tube can have ⅛″ thick walls, is tubular in shape, and is open at both ends, unless the bottom end is closed using a removably attachable bottom.

The top end of a plant care tube can sometimes serve to provide support for the plant, also facilitating use of other plant support devices, such as a tomato cage.

The top end of the plant care tube provides protection from wind, weeds, and insects.

The plant care tube facilitates maximum usage of garden space.

The plant care tube is easy to install, easy to use and reuse, and results in improved plant health.

The plant care tube can be made in various colors, sizes, and cross-sectional shapes. Smaller tubes (1 ½″×3″) can be used in nurseries, or by home gardeners for seed starting. Users of the plant care tubes can include farmers, nurseries, home gardeners, and landscapers.

Tomatoes, peppers, peonies, and a large number of other plants often require support structures as they grow to their full size. The plant care tubes of the invention can enhance the use of such support structures by providing a base of support. For example, a plant care tube also can provide support for a 48″ tomato cage by sliding the bottom prongs of the cage down along the inner wall of the plant care tube. This arrangement can provide greater support and stability as a tomato plant grows, and can substantially eliminate the chance of wind damage in typical weather conditions.

A plant care tube is easy to use. A plant care tube can be installed around a plant simply by pushing it into the soil surrounding the plant. If the soil does not yield to pushing, a few simple strokes with a widger tool or spade will create the void needed to place both the plant and the bottom half of the tube into the ground. Then, six inches of soil can be placed inside and outside the tube so as to create both a plant bed inside the tube, and a solid base outside the tube.

The 6″ of tube extending upward from the inside soil level then advantageously provides a volume of space (a reservoir) that can receive a consistent amount of water regularly for consistent watering.

The plant bed formed by the soil within the plant care tube is saturated by the slow release of water, thereby enabling the roots of the plant to absorb the water and any added nutrients to thereby become well-nourished and healthy, resulting in optimum production from the plant.

The plant care tube also helps to minimize water waste, since all that is needed is to fill the reservoir portion of the plant care tube every other day, for example.

The plant care tube of the invention can promote the growth of various vegetables, flowers, shrubs, or even fruit trees. In effect, the plant care tube allows a controlled environment beneficial to plant health, beauty, and yield.

The plant care tube can also control weeds and insects, the walls of the tube imposing a barrier thereto. The plant care tube facilitates containment of mulch around the plant.

The plant care tube of the invention can be used to enhance the growing of tomatoes, peppers, summer squash, and hydrangeas, dramatically improving yields. Sickly hydrangea shrubs when first transplanted can become heathy and flourishing within 2 weeks.

To use the plant care tubes with tomatoes, peppers, and summer squash, place 6″ of tube below grade, 6″ above grade. The diameter of the tube should be 10″. The tomatoes and peppers should be watered 2-3 time a week. Hydrangeas need a tube of 24″ diameter.

When the soil in a garden is loose, inserting the bottom of a plant care tube can be easily accomplished by turning and pushing the tube. For example, the root base of tomato and pepper plants can be placed approximately 4″ BELOW the bottom of the tube. Hydrangeas can be done in the same manner, but will required a shovel to make the hole. Summer squash can be planted by seed directly in the plant care tube itself, installed the same way.

⅛″ thick tube walls are sufficient for vegetables and flowers. ¼″ thick tube walls can be used for shrubs. The thickness of the plant care tube wall can be relatively thicker for insertion into more dense or compact soil types.

Plant care tubes can be made from plastic, such as polypropylene. This plastic, which is readily available in a variety of colors, is reasonably priced and is easily formed by a wide range of plastic producers. Injection molding can be used to produce the plant care tubes and the removably attachable bottom. Polypropylene is a high impact plastic with excellent tensile strength and is resistant to heat and chemicals. The plastic can be ⅛″ thick, for example, sized to adapt the plant care tube to whatever application for which it would be used (e.g., vegetables, flowers, or shrubs).

Protection of plants using plant care tubes will provide substantial financial benefits. The cost of prematurely replacing plants can be avoided, and water can be more efficiently delivered to the roots, thereby saving water and associated costs. Further, the plant care tubes of the invention can be reused many times. The plant care tubes can also be disposable.

The plant care tube can be used to protect weak or damaged plants from further damage. For example, plant care tubes can be used to help broken tomato stalks mend by supporting them in a position to mend. For example, the root of a weak plant was planted in soil approximately 6″ below the base of a 10″ wide×12″ long plant care tube, which was then placed approximately 6″ below grade, and then filled with soil to about 6″ from top of plant care tube. This allowed the soil to surround the stalk of the weak plant, thereby keeping it upright.

In addition to helping mending broken plant stalks, the plant care tube can protect seedlings from wind damage. Thus, the plant care tubes can be used to help many plants, shrubbery, and trees to grow in less than ideal conditions.

The plant care tube is especially advantageous in areas of drought, because the tube can help to sequester moisture around the roots of the plant. By helping plants to resist drought, the tube of the invention can help reduce the world food crisis.

A general aspect of the invention is an apparatus for helping the growth of a plant. The apparatus includes: a first tube having a cross-section, the first tube having a width configured to accommodate lateral growth of both foliage and roots of a plant, and having a length configured to surround at least half of the height and at least half of the depth of the foliage and the roots, respectively, the first tube also having a top end and a bottom end, the bottom end having attachment features; and a removably attachable bottom having attachment features configured to cooperatively attach to the attachment features of the first tube, so as to thereby form a nursery pot.

In some embodiments, the first tube is a cylinder having a round-shaped cross-section, and the removably attachable bottom is round-shaped.

In some embodiments, the first tube is a square tube having a substantially square-shaped cross-section, the square tube having rounded corners, and the removably attachable bottom is square-shaped having rounded corners.

In some embodiments, the apparatus further includes a second tube having a cross-section similarly shaped as the cross-section of the first tube, the second tube having a width that is 1-3 inches wider than the width of the first tube, and having a length that is 1-3 inches longer than the length of the first tube, so as to keep up with growth of the plant.

In some embodiments, the bottom end of the first tube, and the removably attachable bottom, each have cooperative molded attachment features.

In some embodiments, the removably attachable bottom is solid.

In some embodiments, the removably attachable bottom has drainage holes.

In some embodiments, the first tube has a length of 10 to 14 inches.

In some embodiments, the first tube has a width of 10 inches.

In some embodiments, the first tube has a length of 12 inches, and a diameter of 10 inches.

Another general aspect of the invention is a method for growing plants from seedlings. The method includes: selecting a first tube of a width and a length; removably attaching a bottom having attachment features to cooperative attachment features of a bottom end of the first tube, so as to thereby form a nursery pot; filling the nursery pot with soil; planting seeds in the soil, and allowing the seeds to grow into seedlings having roots that are too large for the nursery pot; removing the bottom from the first tube; placing the first tube along with the soil and the seedling into prepared ground such that half of the first tube extends below ground level, and half of the first tube extends above ground level.

In some embodiments, the method further includes: selecting a second tube of a greater width than the first tube, and a greater length than the first tube; and placing a second tube into prepared ground surrounding the first tube such that half of the second tube extends below ground level, and half of the second tube extends above ground level; and pulling up and removing the first tube leaving the seedling and the soil, so as to allow the roots of seedling to grow from the soil into the prepared ground contained within the second tube.

In some embodiments, the method further includes: adding or removing soil from a top end of the first tube so as to leave a volume of space at the top end sufficient to receive a quantity of water; and regularly providing the quantity of water to the top end of the first tube.

In some embodiments, the method further includes: placing a plant support structure into a top end of the second tube, such that the plant support structure is stabilized by an inner wall of the top end of the second tube.

Yet another general aspect of the invention is a set of tubes for helping the growth of a plant. The set of tubes includes: a first tube having a cross-section, the first tube having a width configured to accommodate lateral growth of both foliage and roots of a plant, and having a length configured to surround at least half of the height and at least half of the depth of the foliage and the roots, respectively, the first tube also having a top end and a bottom end, the bottom end having attachment features; a removably attachable bottom having attachment features configured to cooperatively attach to the attachment features of the first tube, so as to thereby form a nursery pot; a second tube having a cross-section similarly shaped as the cross-section of the first tube, the second tube having a width that is 1-3 inches wider than the width of the first tube, and having a length that is 1-2 inches longer than the length of the first tube, so as to keep up with growth of the plant; and a third tube having a cross-section similarly shaped as the cross-section of the second tube, the third tube having a width that is 1-3 inches wider than the width of the second tube, and having a length that is 1-2 inches longer than the length of the second tube, so as to keep up with growth of the plant.

In some embodiments, the first tube, second tube, and third tubes are cylinders having a round-shaped cross-section, and the removably attachable bottom is also round-shaped.

In some embodiments, the first tube, second tube, and third tubes are square tubes having a substantially square-shaped cross-section, the square tubes having rounded corners, and the removably attachable bottom is also square-shaped having rounded corners.

In some embodiments, the bottom end of the first tube, and the removably attachable bottom, each have cooperative molded attachment features.

In some embodiments, the first tube has a length of 3 1/2 inches, and a width of 5 inches.

In some embodiments, the second tube has a length of 4 inches, and a width of 8 inches.

### BRIEF DESCRIPTION OF THE DRAWINGS

Many additional features and advantages will become apparent to those skilled in the art upon reading the following description, when considered in conjunction with the accompanying drawings, wherein:

FIG. 1A is a perspective view of a cylindrical embodiment of a plant care tube having a top and bottom end, the bottom end having attachment features that engage with the attachment features of a removably attachable bottom to form a nursery pot.

FIG. 1B is an exploded perspective view of the cylindrical embodiment of FIG. 1A, showing the attachment features of the bottom end of the plant care tube, and the removably attachable bottom with corresponding attachment features.

FIG. 2A is a perspective view of a square tube embodiment of a plant care tube having a top and bottom end, the bottom end having attachment features that engage with the attachment features of a removably attachable bottom to form a nursery pot.

FIG. 2B is an exploded perspective view of the square tube embodiment of FIG. 2A, showing the attachment features of the bottom end of the plant care tube, and the removably attachable bottom with corresponding attachment features.

FIG. 3A is a cross-sectional view of a plant care tube with a bottom removably attached to form a nursery pot, the nursery pot containing soil and seedling growing in the soil, also showing another configuration of attachment features that engage on an inner surface of the bottom of the plant care tube.

FIG. 3B is a cross-sectional view of a plant care tube with yet another embodiment of a bottom removably attached to form a nursery pot, the nursery pot containing soil and a larger seedling, also showing another configuration of attachment features that engage on an outer surface of the bottom of the plant care tube.

FIG. 4 is a cross-sectional side view of the plant care tube of FIG. 3B with the bottom removed, still containing the soil and the larger seedling, the tube placed in prepared ground, along with a second tube of a greater width and a greater length buried with additional soil concentrically around the first tube, such that about half of the second tube extends below ground level, and about half of the first tube extends above ground level.

FIG. 5 is a cross-sectional side view of the larger seedling of FIG. 4 grown even larger into the second tube after the first tube has been pulled up and removed, leaving the seedling and the soil, so as to allow the roots of seedling to grow from the soil into the prepared ground contained within the second tube.

FIG. 6 is a side view of a plant and a cross-sectional side view of the second tube of FIG. 5, having a plant support structure placed into the top end of the second tube, such that the plant support structure is stabilized by an inner wall of the top end of the second tube.

FIG. 7A is a flow chart of a method for growing plants from seedlings using plant care tubes.

FIG. 7B is a continuation of the flow chart of the method of FIG. 7A, showing more steps of the method for growing plants from seedlings using plant care tubes.

### DETAILED DESCRIPTION

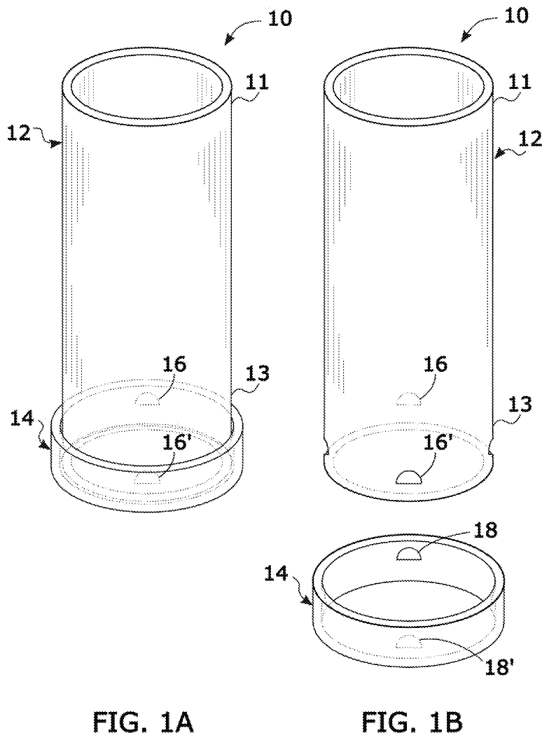

With reference to FIGS. 1A and 1B, a cylindrical embodiment 10 of a plant care tube 12 is shown. The tube 12 has a top end 11 and a bottom end 13, the bottom end 13 having attachment features 16 and 16′ that engage with the attachment features 18 and 18′ of a removably attachable bottom 14 to form a nursery pot 12/14.

FIG. 1B shows an exploded perspective view of the cylindrical embodiment 10 of FIG. 1A, showing the attachment features 16 and 16′ of the bottom end 13 of the plant care tube 12, and the removably attachable bottom 14 with corresponding attachment features 18 and 18′.

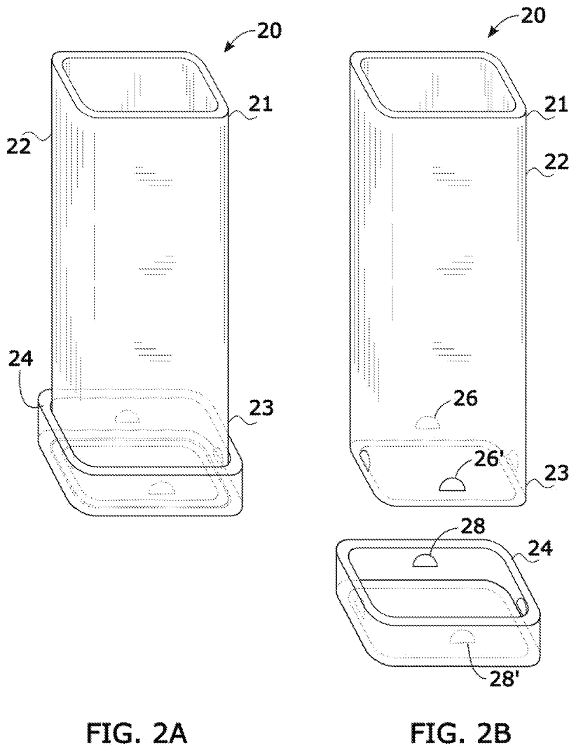

With reference to FIGS. 2A and 2B, a square tube embodiment 20 of a plant care tube 22 is shown. The tube 22 has a top end 21 and a bottom end 23, the bottom end 23 having attachment features 26 and 26′ that engage with the attachment features 28 and 28′ of a removably attachable bottom 24 to form a nursery pot 22/24.

FIG. 2B is an exploded perspective view of the square tube embodiment 20 of FIG. 2A, showing the attachment features 26 and 26′ of the bottom end 23 of the plant care tube 22, and the removably attachable bottom 24 with corresponding attachment features 28 and 28′.

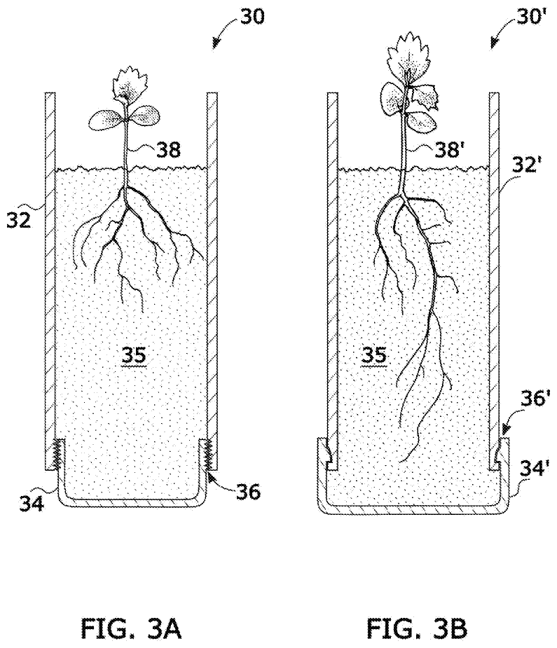

With reference to FIG. 3A, a cross-sectional view is shown of an embodiment 30 of a plant care tube 32 with a bottom 34 removably attached to form a nursery pot 32/34, the nursery pot 32/34 containing soil 35 and seedling 38 growing in the soil 35, also showing another embodiment 36 of attachment features that engage with an inner surface of the bottom of the plant care tube 32.

With reference to FIG. 3B, a cross-sectional view is shown of an embodiment 30′ of a plant care tube 32′ with yet another embodiment 34′ of a bottom removably attached to form a nursery pot 32′/34′, the nursery pot 32′/34′containing soil 35 and a larger seedling 38′, also showing another embodiment 36′ of attachment features that engage with an outer surface of the bottom of the plant care tube 32′.

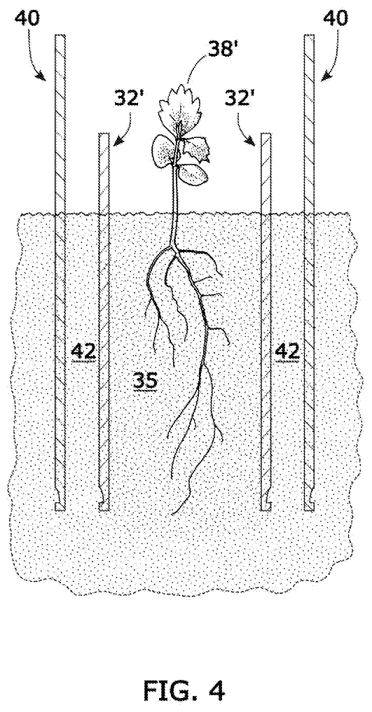

Referring to FIG. 4, a cross-sectional side view is shown of the plant care tube 32′ of FIG. 3B with the bottom 34′ removed, still containing the soil 35 and the larger seedling, the tube placed in prepared ground, along with a second tube of a greater width and a greater length buried with additional soil concentrically around the first tube, such that about half of the second tube extends below ground level, and about half of the first tube extends above ground level.

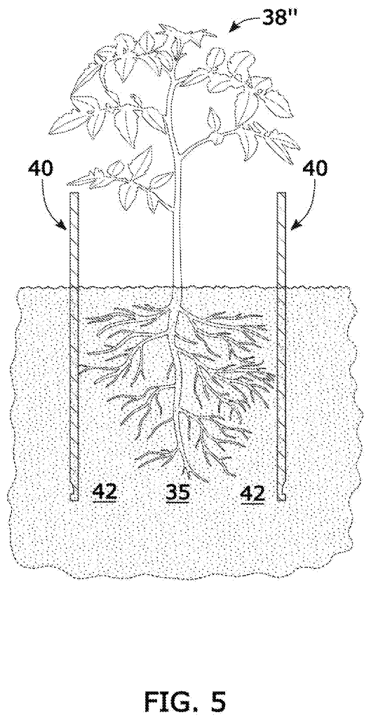

Referring to FIG. 5, a cross-sectional side view is shown of the larger seedling 38′ of FIG. 4, grown even larger 38″ into the soil 42 of second tube 40 after the first tube 32′ has been pulled up and removed, leaving the seedling 38′ and the soil 35 and 42, so as to allow the roots of seedling 38″ to grow from the soil 35 into the soil 42 contained within the second tube 40.

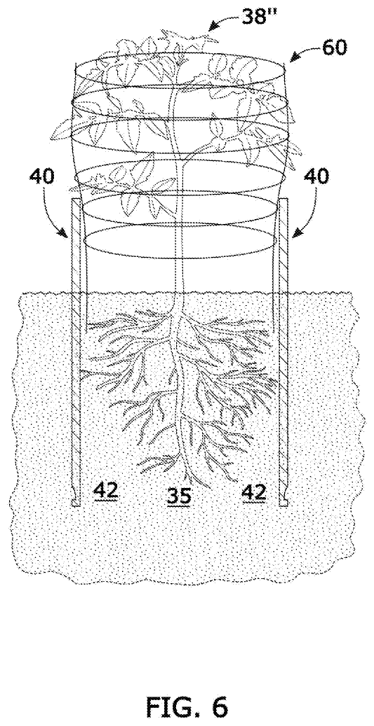

With reference to FIG. 6, a side view of a plant and a cross-sectional side view of the second tube 40 of FIG. 5 is shown. The second tube 40 has a plant support structure 60 placed into the top end of the second tube 40, such that the plant support structure 60 is stabilized by an inner wall of the top end of the second tube 40. Thus, the plant 38″ can grow taller, and the root structure of the plant 38″ can grow even further into the soil 42 from the soil 35.

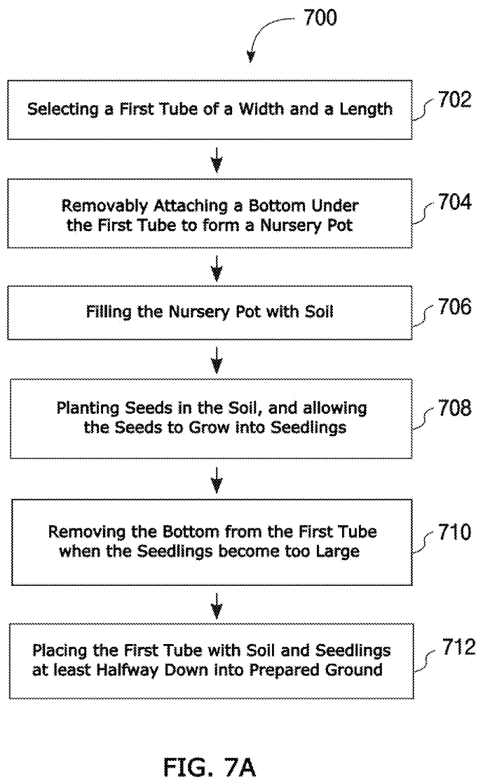

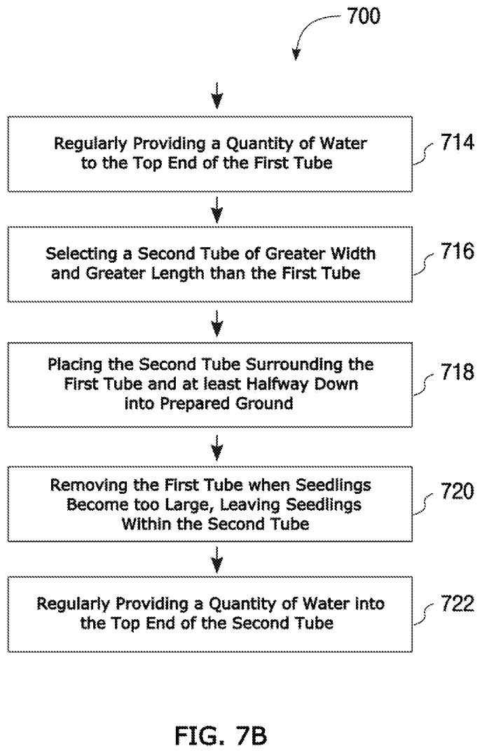

Referring next to FIG. 7A, a flow chart is presented of a method 700 for growing plants from seedlings using plant care tubes, such as those shown in FIGS. 1-6.

To grow a plant from a seedling using a plant care tube of the invention, first one must select 702 a first tube 12 (or 22 or 32, for example), of a width and a length that is sized so as to accommodate a seedling 38 during the early stages of growth.

Then, one removably attaches 704 a bottom 14, for example, having attachment features 18 to a bottom end 13 of the first tube having cooperative attachment features 16, so as to thereby form a nursery pot 10.

Next, one fills 706 the nursery pot 10 with soil.

Then, one plants seeds 708 in the soil, and allows the seeds to grow into seedlings having roots that are too large for the nursery pot.

When the seedlings become too large for the nursery pot 10, one removes 710 the bottom 14 from the first tube 12.

Then, the first tube 12 (or 32′) along with the seedlings 38 and the soil 35 are placed 712 into prepared ground 42 such that half of the first tube 12 (or 32′) extends below ground level, and half of the first tube 12 (or 32′) extends above ground level.

Referring next to FIG. 7B, the flow chart of FIG. 7A is continued, further presenting the method 700 for growing plants from seedlings using plant care tubes, such as those shown in FIGS. 1-6.

It may be necessary to add to or remove soil from the top end 11 of the first tube 12 (or 32′) so as to leave a volume of space at the top end 11 of the first tube 12 (or 32′) that is sufficient to receive a quantity of water that is judged to be appropriate for the particular seedlings in the tube, the particular soil, and the particular local weather conditions, according to one of average skill in the art.

Then, the quantity of water is provided regularly 714 to the top end 11 of the first tube 12 (or 32′).

Next, a second tube 40 is selected 716, the second tube 40 being of a greater width than the first tube 32′, and of a greater length than the first tube 32′, as shown in FIG. 4.

Then, the second tube 40 is placed 718 into prepared ground 42 surrounding the first tube 32′ such that half of the second tube 40 extends below ground level, and half of the second tube 40 extends above ground level.

Next, the first tube 32′ is pulled up and removed 720, leaving the seedling 38′ and the soil 35, so as to allow the roots of seedling 38″ to grow from the soil 35 into the prepared ground 42 contained within the second tube 40, as shown in FIGS. 4 and 5.

It may be necessary to add to or remove soil from the top end 11 of the second tube 40 so as to leave a volume of space at the top end of the second tube 40 that is sufficient to receive a quantity of water that is judged to be appropriate for the particular seedlings in the tube, the particular soil, and the particular local weather conditions, according to one of average skill in the art.

Then, the quantity of water is provided regularly 722 to the top end of the second tube 40.

As the plant 38″ grows even larger, it can be advantageous to place a plant support structure 60 into a top end of the second tube 40, such that the plant support structure 60 is stabilized by an inner wall of the top end of the second tube 40, as shown in FIG. 6.

Other modifications and implementations will occur to those skilled in the art without departing from the spirit and the scope of the invention as claimed. Accordingly, the above description is not intended to limit the invention, except as indicated in the following claims.

What is claimed is:

1. Apparatus for helping the growth of a plant, the apparatus comprising:
a first tube having a cross-section, the first tube having a width configured to accommodate lateral growth of both foliage and roots of a plant, and having a length configured to surround at least half of the height and at least half of the depth of the foliage and the roots, respectively, the first tube also having a top end and a bottom end, the bottom end having attachment features; and
a removably attachable bottom having attachment features configured to cooperatively attach to the attachment features of the first tube, so as to thereby form a nursery pot.

2. The apparatus of claim 1, wherein the first tube is a cylinder having a round-shaped cross-section, and the removably attachable bottom is round-shaped.

3. The apparatus of claim 1, wherein the first tube is a square tube having a substantially square-shaped cross-section, the square tube having rounded corners, and the removably attachable bottom is square-shaped having rounded corners.

4. The apparatus of claim 1, further comprising:
a second tube having a cross-section similarly shaped as the cross-section of the first tube, the second tube having a width that is 1-3 inches wider than the width of the first tube, and having a length that is 1-3 inches longer than the length of the first tube, so as to keep up with growth of the plant.

5. The apparatus of claim 1, wherein the bottom end of the first tube, and the removably attachable bottom, each have cooperative molded attachment features.

6. The apparatus of claim 1, wherein the removably attachable bottom is solid.

7. The apparatus of claim 1, wherein the removably attachable bottom has drainage holes.

8. The apparatus of claim 1, wherein the first tube has a length of 10 to 14 inches.

9. The apparatus of claim 1, wherein the first tube has a width of 10 inches.

10. The apparatus of claim 1, wherein the first tube has a length of 12 inches, and a diameter of 10 inches.

11. A method for growing plants from seedlings, the method comprising:
selecting a first tube of a width and a length;
removably attaching a bottom having attachment features to a bottom end of the first tube having cooperative attachment features, so as to thereby form a nursery pot;
filling the nursery pot with soil;
planting seeds in the soil, and allowing the seeds to grow into seedlings having roots that are too large for the nursery pot;
removing the bottom from the first tube;
placing the first tube along with the soil and the seedling into prepared ground such that half of the first tube extends below ground level, and half of the first tube extends above ground level.

12. The method of claim 11, further comprising:
selecting a second tube of a greater width than the first tube, and a greater length than the first tube; and
placing a second tube into prepared ground surrounding the first tube such that half of the second tube extends below ground level, and half of the second tube extends above ground level; and
pulling up and removing the first tube leaving the seedling and the soil, so as to allow the roots of seedling to grow from the soil into the prepared ground contained within the second tube.

13. The method of claim 11, further comprising:
adding or removing soil from a top end of the first tube so as to leave a volume of space at the top end sufficient to receive a quantity of water; and
regularly providing the quantity of water to the top end of the first tube.

14. The method of claim 12, further comprising:
placing a plant support structure into a top end of the second tube, such that the plant support structure is stabilized by an inner wall of the top end of the second tube.

15. A set of tubes for helping the growth of a plant, the set comprising:
a first tube having a cross-section, the first tube having a width configured to accommodate lateral growth of both foliage and roots of a plant, and having a length configured to surround at least half of the height and at least half of the depth of the foliage and the roots, respectively, the first tube also having a top end and a bottom end, the bottom end having attachment features;
a removably attachable bottom having attachment features configured to cooperatively attach to the attachment features of the first tube, so as to thereby form a nursery pot;
a second tube having a cross-section similarly shaped as the cross-section of the first tube, the second tube having a width that is 1-3 inches wider than the width of the first tube, and having a length that is 1-2 inches longer than the length of the first tube, so as to keep up with growth of the plant; and
a third tube having a cross-section similarly shaped as the cross-section of the second tube, the third tube having a width that is 1-3 inches wider than the width of the second tube, and having a length that is 1-2 inches longer than the length of the second tube, so as to keep up with growth of the plant.

16. The set of claim 15, wherein the first tube, second tube, and third tubes are cylinders having a round-shaped cross-section, and the removably attachable bottom is also round-shaped.

17. The set of claim 15, wherein the first tube, second tube, and third tubes are square tubes having a substantially square-shaped cross-section, the square tubes having rounded corners, and the removably attachable bottom is also square-shaped having rounded corners.

18. The set of claim 15, wherein the bottom end of the first tube, and the removably attachable bottom, each have cooperative molded attachment features.

19. The set of claim 15, wherein the first tube has a length of 3 1/2 inches, and a width of 5 inches.

20. The set of claim 15, wherein the second tube has a length of 4 inches, and a width of 8 inches.
